(19) United States
(12) Patent Application Publication
(10) Pub. No.: US 2007/0260869 A1
(43) Pub. Date: Nov. 8, 2007

(54) Apparatus and Method for Booting a Computing Device from a NAND Memory Device

(75) Inventors: Nicolas Dade, Santa Cruz, CA (US); Edward Geiger, San Martin, CA (US)

Correspondence Address: INGRASSIA FISHER & LORENZ, P.C., 7150 E. CAMELBACK, STE. 325, SCOTTSDALE, AZ, 85251, US

(73) Assignee: SYMBOL TECHNOLOGIES, INC., Holtsville, NY (US)

(21) Appl. No.: 11/741,953

(22) Filed: Apr. 30, 2007

Related U.S. Application Data
(60) Provisional application No. 60/797,018, filed on May 1, 2006.

(51) Int. Cl. G06F 9/00

(52) U.S. Cl. 713/2

(57) ABSTRACT

Apparatus and methods are provided for booting a computing device from a NAND flash memory. One apparatus includes a NAND memory device including a boot sector configured to store boot code and an FPGA including an internal memory in communication with the NAND memory device. The FPGA is configured to access the boot sector and load the boot code into the internal memory. A method for booting a computing device having a processor, an FPGA, and a NAND memory device including at least one sector storing boot code and a sector storing operational code includes the steps of the FPGA holding the processor in reset and accessing the boot sector. The FPGA also fetches the boot code from the boot sector and stores the boot code in its internal memory. Also disclosed are machine-readable mediums providing logic, which when executed by an FPGA, causes the FPGA to perform the method.

### FIELD OF THE INVENTION

The present invention generally relates to computing devices, and more particularly relates to booting a computing device from a NAND flash memory device.

### BACKGROUND OF THE INVENTION

When a computing device is first powered ON, its main system memory is empty, and the computing device needs to immediately find instructions to tell it what to run to begin operating. The instructions are found within a program often referred to as a Basic Input/Output System (BIOS) or a bootloader.

Since the BIOS is the first set of instructions executed by the processor, the BIOS is usually stored in permanent read-only memory (ROM) so that it is always available for use, even when the rest of the main system memory is empty. Early computing devices stored the BIOS in a ROM chip. Since upgrading the BIOS required that the ROM chip be replaced, modern computing devices store the BIOS in programmable read-only memory (PROM), erasable programmable read-only memory (EPROM), electrically erasable programmable read-only memory (EEPROM) or, most commonly, a NOR flash memory.

The BIOS is responsible for locating a code storage device (e.g., hard drive, compact disk, etc.) so the BIOS can instruct the processor to execute code (i.e., boot code) from the device's boot sector. The boot sector is often operating system specific; however, for most operating systems the main function of the boot sector is to instruct the processor to load the operating system kernel stored in a NAND device into the processor's local memory (e.g., SRAM, DDR, etc.).

Therefore, many computing devices include a device (e.g., ROM, PROM, EPROM, EEPROM, a NOR flash, etc.) for storing the BIOS, and non-volatile RAM (e.g., a NAND flash) for storing the operating system. More specifically, many computing devices include a NOR flash device for booting, and a NAND flash device for storing the operating system.

The inclusion of a NOR flash device for booting and a NAND flash device for operating the computing device increases the cost and “real estate” needed for most computing devices. Accordingly, it is desirable to provide apparatus and methods for booting and operating a computing device from a single flash device. Furthermore, other desirable features and characteristics of the present invention will become apparent from the subsequent detailed description of the invention and the appended claims, taken in conjunction with the accompanying drawings and this background of the invention.

### BRIEF DESCRIPTION OF THE DRAWINGS

The present invention will hereinafter be described in conjunction with the following drawing figures, wherein like numerals denote like elements, and

FIG. 1 is a block diagram illustrating a portion of a prior art computing device having boot code stored in a NOR flash device;

FIG. 2 is a block diagram illustrating a portion of one exemplary embodiment of a computing device including boot code stored in a NAND flash device; and

FIG. 3 is a flow diagram of one exemplary embodiment of a method for booting the computing device of FIG. 2.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

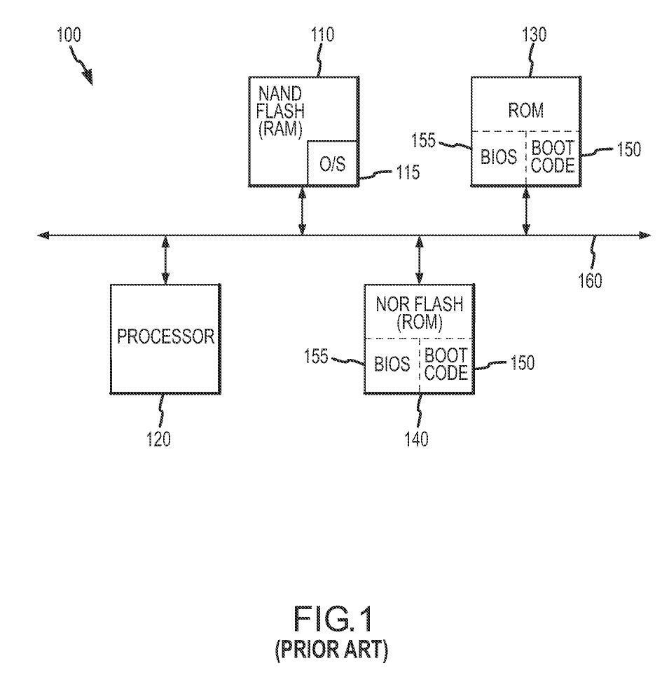

FIG. 1 is a block diagram illustrating a portion of a conventional computing device 100. Computing device 100 includes a NAND flash memory 110 storing operating system (O/S) code 115 (e.g., Windows®, Mac OS®, Linux®, Unix®, and the like operating systems), a processor 120, and ROM 130 and/or NOR flash memory 140 containing a BIOS (or bootloader) 155 and boot code 150. NAND flash memory 110, processor 120, and ROM 130 and/or NOR flash memory 140 are coupled to one another via a bus 160.

When computing device 100 is powered ON, BIOS 150 instructs processor 120 to load boot code 150 from ROM 130 or NOR flash memory 140 to NAND flash memory 1 10. Boot code 150 instructs processor 120 where to find O/S code 115, and instructs processor 120 to load O/S code 115 in its internal memory (not shown). Processor 120 then executes O/S code 115, and the operating system takes over control of the functions of computing device 100.

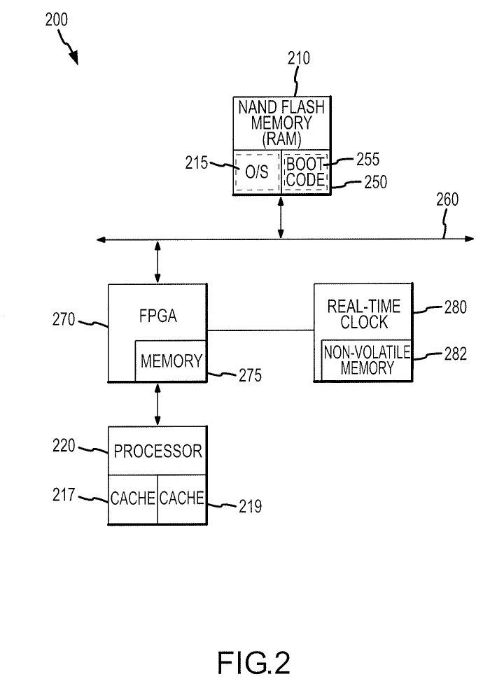

FIG. 2 is a block diagram illustrating a portion of one exemplary embodiment of a computing device 200 that includes a NAND flash memory 210 including a boot sector 250 storing boot code 255, at least one sector 213 storing O/S code 215, a first layer cache memory 217, and a second layer cache memory 219. NAND flash memory 210, in one embodiment, is an 8 bit wide NAND flash memory device. In another embodiment, NAND flash memory 210 is a 16 bit wide NAND flash memory device. Furthermore, boot sector 250 may be, for example, one or more of the lower sectors (e.g., sector 0, 1, 2, and/or 3) of NAND flash memory 210, although various embodiments contemplate that any sector of NAND flash memory may serve as boot sector 250.

Computing device 200 also includes a Field-Programmable Gate Array (FPGA) 270 including an internal memory 275 in communication with a real-time clock 280 having non-volatile RAM 282 and in communication with processor 220. As illustrated in FIG. 2, processor 220 and FPGA 270 are each in communication with NAND flash memory 210 via a bus 260.

FPGA 270 is configured to place and hold processor 220 in “reset” mode when computing device 200 is first powered ON. FPGA 270 is also configured to determine which storage device (i.e., NAND flash memory 210) is storing boot code 255. Furthermore, FPGA 270 is configured to reset NAND flash memory 210 and issue a SECTOR READ command to NAND flash memory 210 to locate boot sector 250.

In one embodiment (e.g., when NAND flash memory is 8 bits wide), FPGA 270 is configured to retrieve boot code 255 from boot sector 250, and then place boot code 255 into internal memory 275. In this embodiment, FPGA 270 is configured to format boot code 255 for the bus width of processor 220 while boot code 255 is in internal memory 275. In another embodiment (e.g., when NAND flash memory 210 is a 16 bits wide), FPGA 270 is configured to format boot code 255 for the bus width of processor 220 while boot code 255 is in boot sector 250.

FPGA 270 is also configured to determine if boot code 255 is valid by calculating a checksum for boot code 255 then comparing the calculated checksum to a known, valid checksum (e.g., 2048 bytes) stored in boot sector 250. If the two checksums match, FPGA 270 releases processor 220 from the reset mode and configures the internal memory (e.g., a double-data-rate synchronous dynamic random access memory (DDR SDRAM)) of processor 220 to access and execute boot code 255 stored in either internal memory 275 or boot sector 250 (depending on whether NAND flash memory 210 is an 8 bit wide device or a 16 bit wide device, respectively). If the two checksums do not match, an error message is transmitted to the user.

Boot code 255 is configured to instruct processor 220 to enable cache memories 217 and 219 so that frequently accessed data may be stored for more rapid access. After the caches memories 217 and 219 are enabled, processor 220 reads the last byte of non-volatile RAM 282 stored in, for example, real-time clock 280 or another memory location (e.g., NAND flash memory 210, EEPROM (not shown), EPROM (not shown), etc.). The last byte of non-volatile RAM 282 informs processor 220 which operating system (e.g., O/S 215) computing device 200 uses, and also instructs processor 220 to execute the operating system. The operating system is then used by processor 220 to control the various operations of computing device 200.

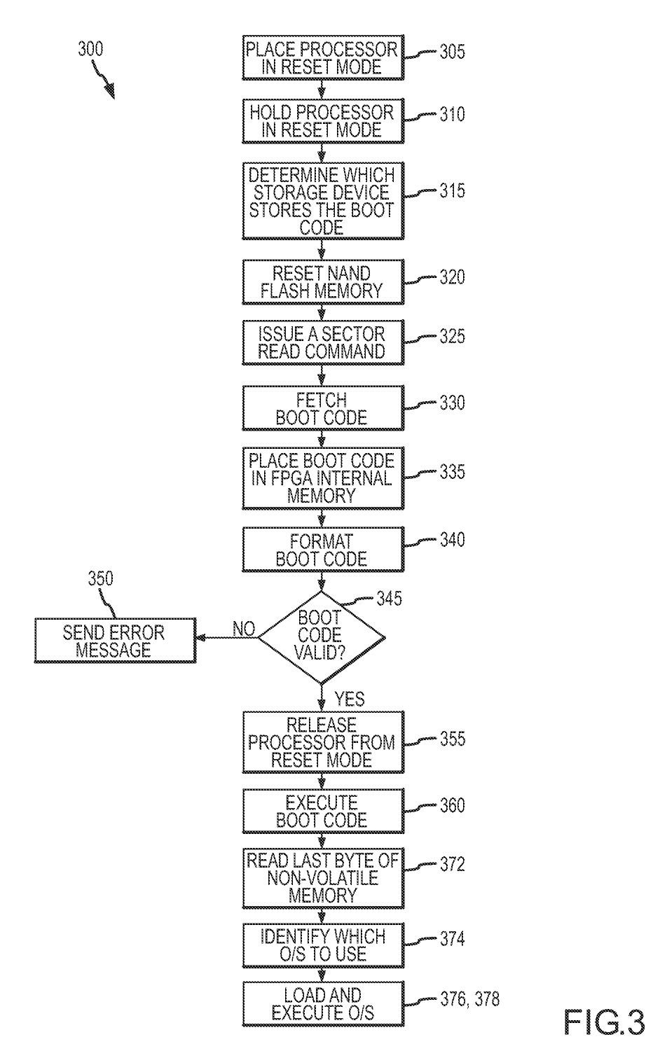

FIG. 3 is a flow diagram of one exemplary embodiment of a method 300 for booting a computing device (e.g., computing device 200). When computing device 200 is first powered ON, an FPGA (e.g., FPGA 270) places a processor (e.g., processor 220) in a reset mode (step 305) and holds processor 220 in reset mode (step 3 10). FPGA 270 then determines which storage device (e.g., NAND flash memory 210) stores the boot code (e.g., boot code 255) for computing device 200 (step 315).

FPGA 270 then resets NAND flash memory 210 (step 320) and issues a SECTOR READ command to NAND flash memory 210 (step 325). The SECTOR READ command enables FPGA 270 to determine how NAND flash memory 210 is configured and whether NAND flash memory 210 is supported by FPGA 270.

FPGA 270 then instructs NAND flash memory 210 to fetch the boot code (e.g., boot code 255) for computing device 200 from a boot sector (e.g., boot sector 250 (e.g., sector 0, 1, 2, or 3)) of NAND flash memory 210 (step 330). After NAND flash memory 210 notifies FPGA 270 it has fetched boot code 255, FPGA 270 places boot code 255 into its internal memory (e.g., memory 275) (step 335) and formats boot code 255 for the bus width of processor 220 (step 340).

Once FPGA 270 has access to boot code 255, FPGA 270 calculates a checksum to ensure that boot code 255 is valid (step 345). To validate boot code 255, the calculated checksum is compared to a known, valid checksum stored in the boot sector 250 of NAND flash memory 210 to determine if the two checksums are the same.

If boot code 255 is not valid, an error message is transmitted to the user (step 350). If boot code 255 is valid (i.e., the checksums match), FPGA 270 releases processor 220 from the reset mode (step 355) and processor 220 executes boot code 255 (step 360).

Processor 220 then reads the last byte of non-volatile RAM (e.g., non-volatile RAM 282) stored in a real-time clock (e.g., real-time clock 280) or other memory location (e.g., NAND flash memory 210) (step 372), which identifies which operating system (e.g., O/S 215) computing device 200 utilizes (step 374). The last byte of the non-volatile RAM 282 also instructs processor 220 to load (step 376) and execute (step 378) O/S 215. Once O/S 215 has been loaded and executed by processor 220, O/S 215 performs the various operations of computing device 200 and the boot sequence is complete.

As may be appreciated by one of ordinary skill in the art, the present invention may be embodied as a computing device, a method, a data processing system, a device for data processing, and/or a computer program product. Accordingly, the present invention may take the form of an entirely software embodiment, an entirely hardware embodiment, or an embodiment combining aspects of both software and hardware or other physical devices. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

Computer program instructions may also be stored in a computer-readable memory that may direct a computer or other programmable data processing apparatus to perform method 300, such that the instructions stored in the computer-readable memory produce an article of manufacture including instruction means which implement functions of a flowchart block or blocks. The computer program instructions may also be loaded onto a computing device or other programmable data processing apparatus to cause a series of operational steps to be performed on the computing device or other programmable apparatus to produce a computer-implemented process such that the instructions which execute on the computer or other programmable apparatus include steps for implementing the functions specified in the flowchart block or blocks.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

We claim:

1. A computing device, comprising:
a NAND memory device including a boot sector configured to store boot code; and
a field programmable gate array (FPGA) including an internal memory in communication with the NAND memory device, the FPGA configured to access the boot sector and load the boot code into the internal memory.

2. The computing device of claim 1, further comprising:
a processor in communication with the FPGA and the NAND memory device, wherein the FPGA is further configured to hold the processor in reset while the FPGA is loading the boot code.

3. The computing device of claim 2, wherein the NAND memory device is further configured to store operational code, and wherein the FPGA is further configured to:
release the processor from reset; and
provide access to the boot code in the internal memory to the processor.

4. The computing device of claim 1, wherein the NAND memory device is further configured to store a valid checksum, and wherein the FPGA is further configured to:
calculate a checksum of the boot code; and
determine if the calculated checksum matches the valid checksum.

5. The computing device of claim 1, wherein the FPGA is further configured to reset the NAND memory device prior to the FPGA accessing the boot sector.

6. A method for booting a computing device having a processor, a field programmable gate array (FPGA) including internal memory, and a NAND memory device including a boot sector storing boot code and at least one sector storing operational code, the method comprising the steps of:
accessing, via the FPGA, the boot sector;
holding the processor in reset;
fetching the boot code from the boot sector; and
storing the boot in the internal memory.

7. The method of claim 6, the method further comprising the steps of:
calculating a checksum of the boot code; and
determining if the calculated checksum is valid.

8. The method of claim 7, further comprising the steps of:
releasing the processor from reset; and
providing access to the boot code in the internal memory to the processor.

9. The method of claim 6, further comprising the step of resetting the NAND memory device prior to the FPGA accessing the boot sector.

10. A machine-readable medium that provides logic, which when executed by a field programmable gate array (FPGA) in communication with a processor and a NAND memory device including at least one boot sector storing boot code causes the FPGA to:
access, via the FPGA, the boot sector;
hold the processor in reset;
fetch the boot code from the boot sector; and
store the boot in the internal memory.

11. The machine-readable medium of claim 10, the logic further causing the FPGA to:
calculate a checksum of the boot code; and
determine if the calculated checksum is valid.

12. The machine-readable medium of claim 11, the logic further causing the FPGA to:
release the processor from reset; and
provide access to the boot code in the internal memory to the processor.

13. The machine-readable medium of claim 10, the logic further causing the FPGA to reset the NAND memory device prior to the FPGA accessing the boot sector.
